(19) United States
(12) Patent Application Publication
(10) Pub. No.: US 2015/0046390 A1
(43) Pub. Date: Feb. 12, 2015

(54) Storing Metadata in a Table-based Format from Metadata in a Serial Format

(71) Applicants: Enping Tu, Cupertino, CA (US); Yanlun Ma, Saratoga, CA (US); Hung-Liang Yang, Fremont, CA (US); Yung-Yin Chen, Cupertino, CA (US)

(72) Inventors: Enping Tu, Cupertino, CA (US); Yanlun Ma, Saratoga, CA (US); Hung-Liang Yang, Fremont, CA (US); Yung-Yin Chen, Cupertino, CA (US)

(73) Assignee: SAP AG, Walldorf (DE)

(21) Appl. No.: 14/018,829

(22) Filed: Sep. 5, 2013

Related U.S. Application Data
(60) Provisional application No. 61/864,396, filed on Aug. 9, 2013.

(51) Int. Cl. G06F 17/30

(52) U.S. Cl. CPC G06F 17/30563
USPC 707/602

(57) ABSTRACT

In one embodiment, a method receives a document including metadata in a serial format and parses the document to determine components in the metadata, a nested structure of the components, and an order of the components in the data. The metadata is stored in a table format where columns of the table define the nested structure of the components and the order of the components in the data. A query is received for the data. The method determines components from the metadata stored in the table format from the columns that satisfy the query where the components are determined based on the nested structure of the determined components and the order of the determined components from information in the columns of the table. A result for the query is output including the determined components based on the nested structure of the determined components and the order of the determined components.

### CROSS-REFERENCE TO RELATED APPLICATION

The instant nonprovisional patent application claims priority to U.S. Provisional Patent Application No. 61/864,396, filed Aug. 9, 2013 and incorporated by reference in its entirety herein for all purposes.

### BACKGROUND

In a traditional database, database tables store data where the tables have only columns as table components. Also, an extraction transform and load tool (ETL tool) stores metadata in the database in two tables called tables and columns. The metadata table stores metadata for tables and the columns metadata table stores metadata about columns. The metadata includes name/attributes/properties, etc. of a table and name/attributes/data type/etc. of a column. In some other solutions, such as on-demand solutions, the data is not read from a database or written to a database directly. Instead, the data is transferred through a web service in a serial format or non-database table format, such as extensible markup language (XML) format. In this case, the metadata is defined with an XML metadata interchange (XMI) format, which is also in a serial or non-database table format. The data in the XML format allows for a compound table (e.g., a table that can have both sub-tables and columns as components recursively). An XMI document defines the order of components in the data (e.g., the sub-tables and columns) and is enforced by the ETL tool.

The ETL tool is configured to work in the database table format. Because the XMI document is not in the database table format, the ETL tool creates a dummy table as a wrapper of the XMI document. The ETL tool then saves the XMI as an attribute of the dummy table. That is, the entire XMI document is saved as the attribute. When the metadata needs to be read, the ETL tool retrieves the XMI document, parses the XMI document at runtime, and provides the metadata to a user interface. The user interface then uses the metadata to display components of the data.

At certain times, a user may edit the data and save the changes through the user interface. For example, a user may add tables or columns, which changes the structure of the data. The changes to the data cause changes in the metadata. Based on the changes, the ETL tool rebuilds the XMI document from scratch to represent the changes and saves the new XMI as an attribute of the dummy table. Due to the characteristics of the XMI format, the ETL tool cannot change single instances in the XMI document that is stored as an attribute of the dummy table. Rather, the ETL tool rebuilds the entire XMI document. The above process may be expensive in both CPU and memory usage. For example, the parsing and rebuilding of the XMI document may be tedious and error-prone. Further, the entire XMI document needs to be read because the XMI document is stored as an attribute of the dummy table.

### SUMMARY

In one embodiment, a method receives a document including metadata in a serial format and parses the document to determine components in the metadata, a nested structure of the components, and an order of the components in the data. The metadata is stored in a table format where columns of the table define the nested structure of the components and the order of the components in the data. A query is received for the data. The method then determines components from the metadata stored in the table format from the columns of the table that satisfy the query where the components are determined based on the nested structure of the determined components and the order of the determined components from information in the columns of the table. A result for the query is output including the determined components based on the nested structure of the determined components and the order of the determined components.

In one embodiment, a non-transitory computer-readable storage medium contains instructions, that when executed, control a computer system to be configured for: receiving a document including metadata in a serial format; parsing the document to determine components in the metadata, a nested structure of the components, and an order of the components in the data; storing the metadata in a table format, wherein columns of the table define the nested structure of the components and the order of the components in the data; receiving a query for the data; determining components from the metadata stored in the table format from the columns of the table that satisfy the query, wherein the components are determined based on the nested structure of the determined components and the order of the determined components from information in the columns of the table; and outputting a result for the query, the result including the determined components based on the nested structure of the determined components and the order of the determined components.

In one embodiment, an apparatus includes: one or more computer processors; and a non-transitory computer-readable storage medium comprising instructions, that when executed, control the one or more computer processors to be configured for: receiving a document including metadata in a serial format; parsing the document to determine components in the metadata, a nested structure of the components, and an order of the components in the data; storing the metadata in a table format, wherein columns of the table define the nested structure of the components and the order of the components in the data; receiving a query for the data; determining components from the metadata stored in the table format from the columns of the table that satisfy the query, wherein the components are determined based on the nested structure of the determined components and the order of the determined components from information in the columns of the table; and outputting a result for the query, the result including the determined components based on the nested structure of the determined components and the order of the determined components.

The following detailed description and accompanying drawings provide a better understanding of the nature and advantages of particular embodiments.

### BRIEF DESCRIPTION OF THE DRAWINGS

FIG. 1 depicts a system for storing metadata in a database table format according to one embodiment.

FIG. 2A shows an example of an XMI document 201 according to one embodiment.

FIG. 2B shows an example of a structure of components in the XMI document that are arranged in a nested structure in a specific order according to one embodiment.

FIG. 2C shows a first metadata table for tables according to one embodiment.

FIG. 2D shows a second metadata table for columns according to one embodiment.

FIG. 3A shows an example of a user interface displaying the structure of the metadata that is retrieved according to one embodiment.

FIG. 3B shows an example of the user interface when table T2 is expanded.

FIG. 4A shows an example of adding a component of a table T6 below column C2 according to one embodiment.

FIG. 4B shows a modified first metadata table according to one embodiment.

FIG. 4C shows a modified second metadata table according to one embodiment.

FIG. 5A shows an example of deleting a component according to one embodiment.

FIG. 5B shows the changes to a first metadata table according to one embodiment.

FIG. 5C shows the changes to a second metadata table according to one embodiment.

FIG. 6 depicts a simplified flowchart of a method for storing metadata in metadata tables according to one embodiment.

FIG. 7 depicts a simplified flowchart of a method for responding to queries from a user interface according to one embodiment.

FIG. 8 depicts a more detailed example of an ETL tool according to one embodiment.

FIG. 9 illustrates hardware of a special purpose computing machine configured with the ETL tool according to one embodiment.

### DETAILED DESCRIPTION

Described herein are techniques for a metadata processing system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

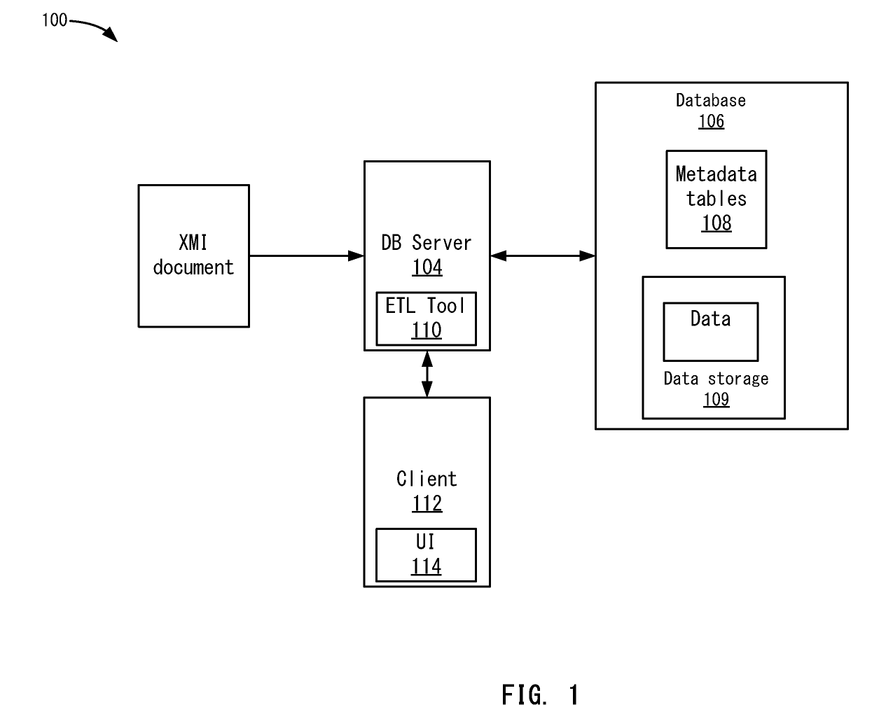

FIG. 1 depicts a system 100 for storing metadata in a database table format according to one embodiment. A database system 102 includes a database server 104 and a database 106. Variations of database system 102 will be appreciated. Database server 104 interacts with database 106 to retrieve data and metadata that describes the data. For example, an ETL tool 110 extracts the metadata from metadata tables 108 and the data from data storage 109. In one embodiment, database 106 stores the metadata in a database table format and the data in a serial format or non-database table format. For example, the data is stored in an XML format and provided through a web service on demand. Although the term XML is used for discussion purposes, it will be understood that other serial formats may be used in place of XML.

In one embodiment, ETL tool 110 receives a document that describes the data stored in the XML format. The document may be an XMI document and the data may be in an XML format. The data in the XML document includes tables that may be nested, that is, tables can have both sub-tables and columns as components. Allowing both sub-tables and columns as attributes of tables may be different from a traditional database table that only allows columns. Also, the sub-tables and columns may be in a specific ordering. The XMI document describes the nested structure and the ordering of the data.

ETL tool 110 receives the XMI document and stores information that represents the metadata in metadata tables 108. In this way, ETL tool 110 takes advantage of the table format that database 106 can use. Instead of storing the XMI document as an attribute for a table, ETL tool 110 generates information in columns of metadata tables 108 that describes the metadata in the XMI document. In one embodiment, metadata tables 108 include a first metadata table 108 that describes tables in the data and a second metadata table 108 that describes columns.

Particular embodiments store the metadata in columns that are used to describe the nested structure of components described in the XMI document and also the order of the components described in the XMI document. The columns identify the parent table for components, a previous component, and a next component. In one embodiment, a first column PARENT_TABLE_GUID includes an identifier for the parent table for a current component; a second column PREVIOUS_COMPONENT_GUID includes an identifier for a previous component in the order for a current component; a third column PREVIOUS_COMPONENT_TYPE includes the type of the previous component (e.g., 0=table, 1=column); a fourth column NEXT_COMPONENT_GUID includes an identifier for a next component in the order to the current component; and a fifth column NEXT_COMPONENT_TYPE includes the type of the next component (e.g., 0=table, 1=column). ETL tool 110 parses the XMI document and stores information in the five columns to represent the metadata found in the XMI document.

A client 112 may send queries to database server 104 to display information on a user interface 114 that represents the data stored in database 106. For example, client 112 queries for the structure of the data stored in database 106. In one example, a user may want to display the nested structure or ordering of tables and columns in the data. When database server 104 receives a query, ETL tool 110 queries metadata tables 108 for relevant metadata for the query. Based on the metadata stored in the columns of tables 108, ETL tool 110 returns a result to client 112 where user interface 114 displays the results. For example, user interface 114 displays the nested structure of certain components and ordering of the components.

In another embodiment, a user may edit the data stored in database 106. For example, a user may add a component or delete a component from the data using user interface 114. When this occurs, client 112 sends information for the change to ETL tool 110. ETL tool 110 may then change the metadata stored in the columns to represent the changes the user performed using user interface 114. In one embodiment, ETL tool 110 does not need to change the XMI document that includes the metadata when the change occurs. Rather, ETL tool 110 only makes the changes in the columns of metadata tables 108. In one embodiment, if a new XMI document is required, ETL tool 110 may generate the new XMI document from the metadata stored in the columns in metadata tables 108. This avoids unnecessary regeneration of the XMI document if the XMI document is not needed.

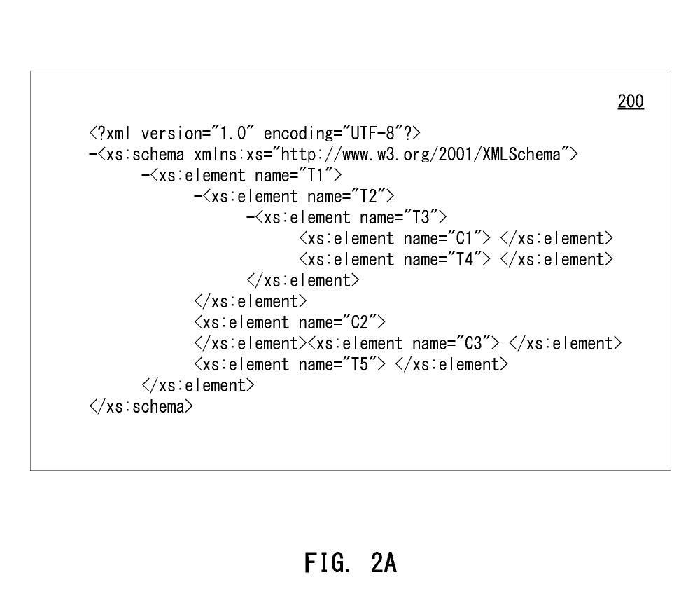

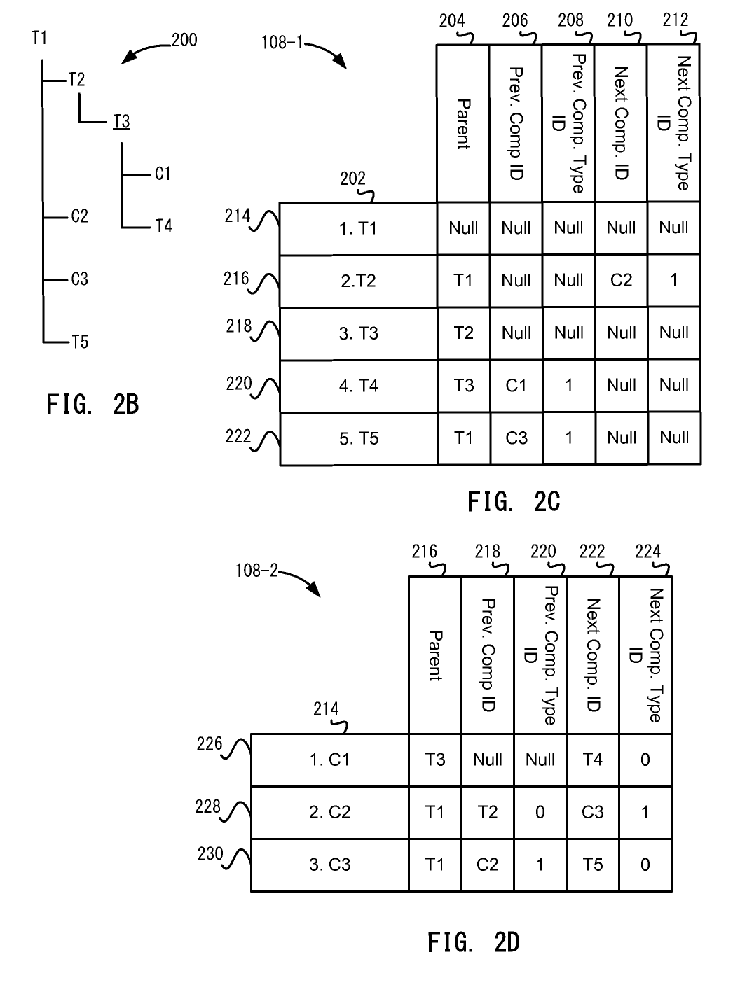

FIG. 2A shows an example of an XMI document 201 according to one embodiment. The XMI document describes data that includes tables T1, T2, T3, T4, and T5 and columns in the tables of C1, C2, and C3. The XMI document also describes the nested structure and ordering of the components in the data.

FIG. 2B shows an example of a structure of components in the XMI document that are arranged in a nested structure in a specific order according to one embodiment. For example, the data includes tables T1, T2, T3, T4, and T5 and columns in the tables of C1, C2, and C3. For example, the column C1 is a column in table T3 and the columns C2 and C3 are columns in table T1. Tables may also have sub-tables. For example, table T5 is a sub-table of table T1; table T2 is a sub-table of table T1; table T3 is a sub-table of table T2; and table T4 is a sub-table of table T3.

In one embodiment, user interface 114 may want to display the nested structure of the components and/or the order of the components. To display the structure, metadata tables 108 as described above are used. FIG. 2C shows a first metadata table 108-1 for tables and FIG. 2D shows a second metadata table 108-2 for columns according to one embodiment. Metadata tables 108-1 and 108-2 describe the nested structure and the order of the components in the data.

In FIG. 2C, values in metadata table 108-1 describe the nested structure and the ordering of the components for each table in the data. For example, column 202 identifies each table in the metadata. A column 204 identifies the parent identifier (e.g., the first column PARENT_TABLE_GUID); a column 206 identifies a previous component identifier (e.g., the second column PREVIOUS_COMPONENT_GUID); a column 208 identifies the previous component type (e.g., the third column PREVIOUS_TYPE_GUID); a column 210 identifies the next component identifier (e.g., the fourth column NEXT_COMPONENT_GUID); and a column 212 identifies the next component type (e.g., the fifth column NEXT_COMPONENT_TYPE).

For each respective table in the data, metadata table 108-1 lists information for the five columns. For example, at 214, for a table T1, the values for the five columns 204-212 are null. This is because table T1 is the root table and does not have a parent table or any previous components or next components in the ordering.

At 216, the metadata for table T2 is shown. For column 204, the parent table for table T2 is table T1. Values for columns 206 and 208 are null because T2 does not have a previous component. However, for columns 210 and 212, the next component for table T2 is column C2. Thus, column 210 includes the value of the identifier for column C2 and column 212 inserts the value of “1” for the component type of a column.

At 218, the metadata for table T3 is shown. In column 204, the parent for table T3 is listed as table T2. The rest of the values for columns 206, 208, 210, and 212 are null because table T3 does not have a previous component or next component in the structure.

At 220, the metadata for table T4 is shown. In column 204, the parent component for table T4 is table T3. Also, in columns 206 and 208, column C1 is the previous component and this component is a column. Columns 210 and 212 include the values of null because table T4 does not have a next component in the structure.

At 222, the metadata for table T5 is shown. In column 204, the parent to table T5 is table T1. Also, in columns 206 and 208, the previous component for table T5 is component C2 and this component is a column. Columns 210 and 212 include the values of null because table T5 does not have a next component in the structure.

In FIG. 2D, metadata table 108-2 summarizes the columns in the data. A column 214 identifies each column in the data; and columns 216, 218, 220, 222, and 223 are similar to columns 204, 206, 208, 210, and 212, respectively. At 226, the metadata for column C1 is described. In column 216, the parent component to column C1 is table T3. Column C1 does not have any previous components and the values in columns 218 and 220 include the values of null. Column C1 includes a next component and the values for columns 222 and 224 identify table T4 and a type of 0 for a table.

At 228, the metadata for column C2 is described. In column 216, the parent component of table T1 is identified for column C2. In columns 218 and 220, the previous component for column C2 is table T2 and the table T2 is identified with a type of 0 for a table. In columns 222 and 224, the next component for column C2 is column C3 and column C3 is identified with a type of 0.

At 230, the metadata for column C3 is described. In column 216, the parent of column C3 is table T1. In columns 218 and 220, column C2 is the previous component for column C3 and the type is 0 for a column. Also, in columns 222 and 224, table T5 is the next component for column C3 and the type is 0 for table.

The above information in metadata tables 108-1 and 108-2 describes the metadata found in the XMI document. When queries for the metadata are received at ETL tool 110, ETL tool 110 uses metadata tables 108-1 and 108-2 to respond to the queries instead of using the metadata found in the XMI document. Retrieving data from database columns may be faster than parsing the whole XMI document. This is because ETL tool 110 can randomly access metadata tables 108-1 and 108-2 and also perform queries for values in columns. In contrast, ETL tool 110 would have to read in and parse the entire XMI document to respond to a query.

In one embodiment, ETL tool 110 uses two procedures to read the metadata from metadata tables 108-1 and 108-2. A first procedure reads a compound table with all of its sub-tables. The first procedure retrieves all of the tables in one compound table definition. The result of the first procedure guarantees that a parent table always appears before its children. Also, the first procedure includes a parameter “max_layer” that can control how many layers of the compound table are queried. In doing this, ETL tool 110 does not need to read all of the metadata in metadata tables 108-1 and 108-2. Also, user interface 114 does not have to render all the tables/columns in the compound table at one time. For example, a compound table may have twenty layers and each layer has around fifty components. If all of these are loaded, user interface 114 may take a long time to render the structure even though most of the components are not needed at one time.

Using the first procedure, ETL tool 110 may retrieve all of the tables in the structure 200. For example, reading the first layer, the procedure determines the table T1. the first procedure determines table T1 because table T1 is the only table in the top most layer. Then, moving to the next layer, the procedure determines the tables T2 and T5, which are the only tables in the second layer. After the second layer, the procedure determines table T3, which is the only table in a third layer. Then after the third layer, the procedure determines table T4, which is in a fourth layer. Using the above, the first procedure determines the nested structure of the tables.

Table 1 includes code that may be used to read the compound table according to one embodiment.

```
TABLE I
CREATE PROCEDURE TABLES_WITH_CHILDREN_PROCEDURE (IN guid VARCHAR(50),
IN
  max_layer INT, OUT output_tables TABLES)
  LANGUAGE SQLSCRIPT READS SQL DATA WITH RESULT VIEW
TABLES_WITH_CHILDREN_VIEW AS
  layer_count INT := 0;
  iter_count INT := 1;
  local_max_layer INT := 0;
BEGIN
  output_tables = SELECT * FROM TABLES where GUID = :guid;
  temp_tables = SELECT * FROM :output_tables;
  SELECT count(*) INTO layer_count FROM :temp_tables;
  temp_guids = SELECT GUID FROM :temp_tables;
  local_max_layer := :max_layer;
  IF :max_layer < 0 OR :max_layer > 100 THEN
    local_max_layer := 100;
  END IF;
  WHILE :layer_count != 0 AND iter_count < local_max_layer DO
    iter_count := :iter_count +1; -- prevent infinite loop
    temp_tables = SELECT * FROM TABLES WHERE PARENT_GUID IN
  (SELECT GUID FROM :temp_guids);
    output_tables = CE_UNION_ALL(:output_tables,
  :temp_tables);
    SELECT count(*) INTO layer_count FROM :temp_tables;
    temp_guids = SELECT GUID FROM :temp_tables;
  END WHILE;
END
```

A second procedure queries components of one table in a pre-defined order. The procedure may determine the ordering of the components for the table. For example, for table T1, the second procedure may return the ordering of the components of T2, C2, C3, and T5. For the third table, the second procedure may return the ordering of column C1 and table T4. Table 2 includes code to determine the ordering of a table component.

```
TABLE 2
CREATE TABLE TABLE_COMPONENT(
  NAME NVARCHAR(100),
  GUID VARCHAR(50),
  TYPE INTEGER, -- 0=TABLE, 1=COLUMN
  PREVIOUS_COMPONENT_TYPE INTEGER, -- 0=TABLE, 1=COLUMN
  PREVIOUS_COMPONENT_GUID VARCHAR(50),
  NEXT_COMPONENT_TYPE INTEGER, -- 0=TABLE, 1=COLUMN
  NEXT_COMPONENT_GUID VARCHAR(50)
);
CREATE PROCEDURE GET_ALL_CHILDREN_IN_ORDER (IN guid VARCHAR(50), OUT
  output_table TABLE_COMPONENT)
  LANGUAGE SQLSCRIPT READS SQL DATA WITH RESULT VIEW
  TABLE_COMPONENT_IN_ORDER_VIEW AS
  select_count INT := 0;
  next_type INT := 0;
  pre_guid VARCHAR(50);
BEGIN
  output_table = SELECT NAME, GUID, 1 AS TYPE,
    PREVIOUS_COMPONENT_TYPE, PREVIOUS_COMPONENT_GUID,
    NEXT_COMPONENT_WHERE PARENT_GUID = :guid AND PRE_OBJ_GUID
    IS NULL;
  SELECT COUNT(*) INTO select_count FROM :output_table;
  IF :select_count = 0 THEN
    output_table = SELECT NAME, GUID, 0 AS TYPE,
    PREVIOUS_COMPONENT_TYPE, PREVIOUS_COMPONENT_GUID, WHERE
    DS_TABLE_GUID = :guid AND PRE_OBJ_GUID IS NULL;
  END IF;
  SELECT COUNT(*) INTO select_count FROM :output_table;
  SELECT NEXT_COMPONENT_TYPE INTO next_type FROM :output_table;
  temp_table = SELECT * FROM :output_table;
  WHILE :select_count > 0 DO
    SELECT TOP 1 GUID INTO pre_guid FROM :temp_table;
    temp_table = SELECT TOP 0 * FROM TABLE_COMPONENT;
    IF :next_type=0 THEN
      temp_table = SELECT NAME, GUID, 1 AS TYPE,
        PREVIOUS_COMPONENT_TYPE,
        PREVIOUS_COMPONENT_WHERE PARENT_GUID = :guid
        AND PRE_OBJ_GUID = :pre_guid;
    END IF;
    IF :next_type=1 THEN
      temp_table = SELECT NAME, GUID, 0 AS TYPE,
        PREVIOUS_COMPONENT_TYPE,
        PREVIOUS_COMPONENT_WHERE DS_TABLE_GUID =
        :guid AND PRE_OBJ_GUID = :pre_guid;
    END IF;
    SELECT COUNT(*) INTO select_count FROM :temp_table;
    IF :select_count>0 THEN
      SELECT NEXT_COMPONENT_TYPE INTO next_type FROM
      :temp_table;
      output_table = CE_UNION_ALL(:output_table,
    :temp_table);
    END IF;
  END WHILE;
```

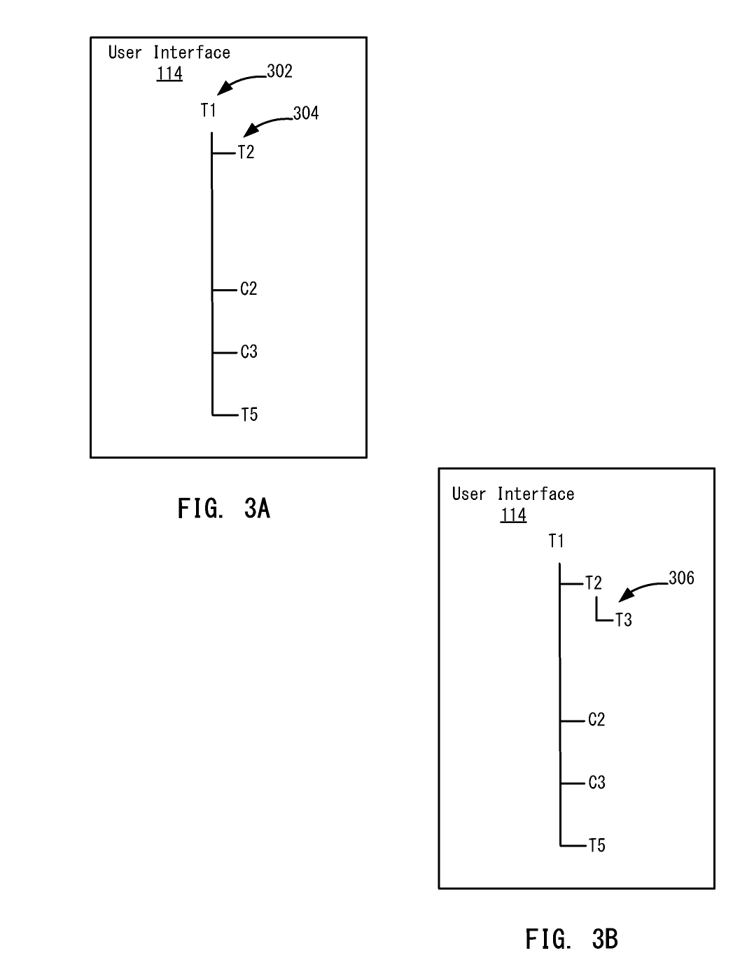

Using the above procedures, ETL tool 110 may provide information to user interface 114 for the structure of the data. For example, to display the structure of table T1 one layer down, ETL tool 110 may use two procedures to retrieve the metadata from metadata tables 108-1 and 108-2. In one example, ETL tool 110 may call the first procedure to determine the tables in the metadata. Then, to get one layer down, ETL tool 110 calls the second procedure to determine the components of Table T1. FIG. 3A shows an example of user interface 114 displaying the structure of the metadata that is retrieved according to one embodiment. As shown, table T1 is identified at 302, and at 304, the structure one layer down is shown as table T2, column C2, column C3, and table T5. User interface 114 does not show further layers of the structure of the data yet.

When a user wants to display another layer down of the structure, the user may expand table T2. FIG. 3B shows an example of user interface 114 when table T2 is expanded. In this case, at 306, table T3 is shown. ETL tool 110 may retrieve the next layer using the information from the first procedure that lists table T3 as the next table in the layers. Further, ETL tool 110 knows that the parent of table T3 is table T2 from the first procedure.

The above described displaying the structure of the data using the metadata. However, a user may also modify the data, which causes a change to the metadata. For example, a user may add or delete a component in the structure. When adding a component, ETL tool 110 may modify the information in metadata tables 108-1 and 108-2 to reflect the modification. For example, due to the adding or deleting of the component, metadata in the columns of metadata tables 108-1 and 108-2 may not reflect the changed structure.

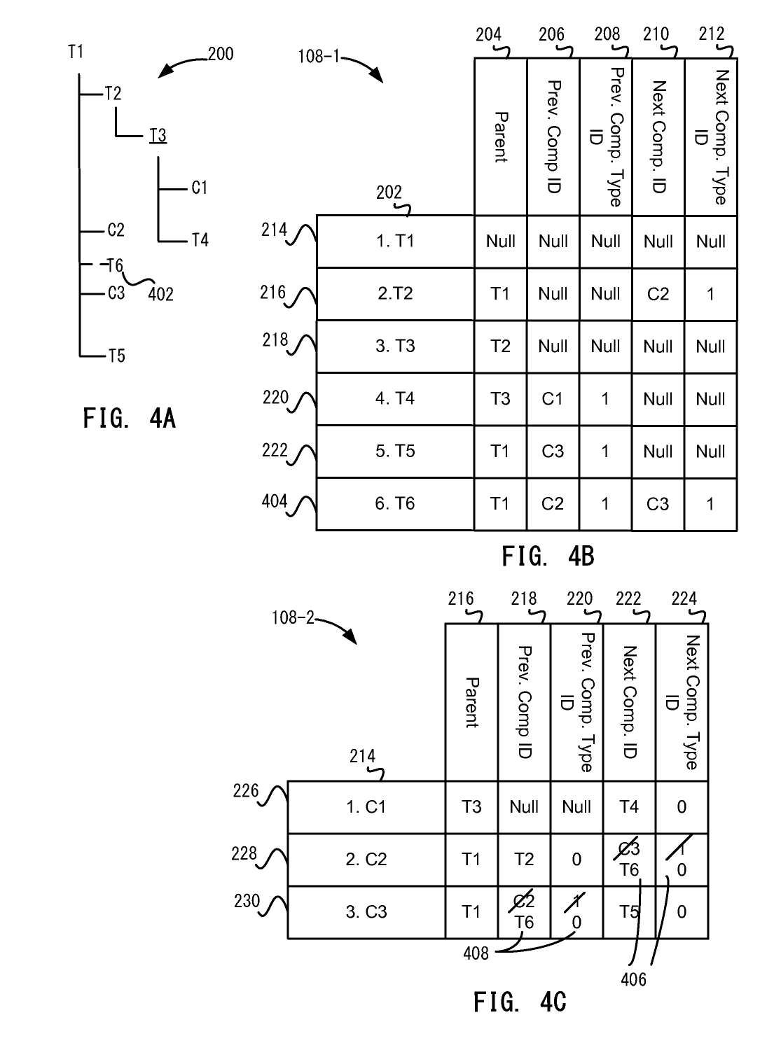

When adding a component, ETL tool 110 adjusts the information in metadata tables 108-1 and 108-2 to reflect the addition. FIG. 4A shows an example of adding a component of a table T6 below column C2 at 402 according to one embodiment. In this case, ETL tool 110 may determine the previous component and next component for column C2 based on information in metadata tables 108-1 and 108-2. For example, ETL tool 110 determines that column C2 has a next component of column C3. The previous component for column C2 is not affected in this case.

ETL tool 110 then adds the table T6 to the metadata. FIG. 4B shows a modified metadata table 108-1 and FIG. 4C shows a modified metadata table 108-2 according to one embodiment. At 404, table 108-1 describes the new component of table T6. The parent of table T6 is table T1 in column 204. Also, in columns 206 and 208, the previous component for table T6 is column C2 and the type is 1 for a column. Also, the next component for table T6 is column C3 and the type is 1 for a column. No other information for tables is affected in metadata table 108-1 and thus ETL tool 110 does not make any other changes to metadata table 108-1.

In FIG. 4C, changes to the previous and next components for columns C2 and C3 are needed due to the addition of table T6. For example, at 406, ETL tool 110 changes information for column C2 because the new next component for column C2 is table T6, and not C3 anymore. Thus, in columns 222 and 224, ETL tool 110 changes the value of column C3 to table T6 and changes the value of the type from 0 to 1 to indicate that a table is the next component. Also, for column C3, the new previous component is table T6. Thus, at 408, ETL tool 110 changes the previous component from column C2 to table T6 and changes the type from 1 to 0 to indicate a table.

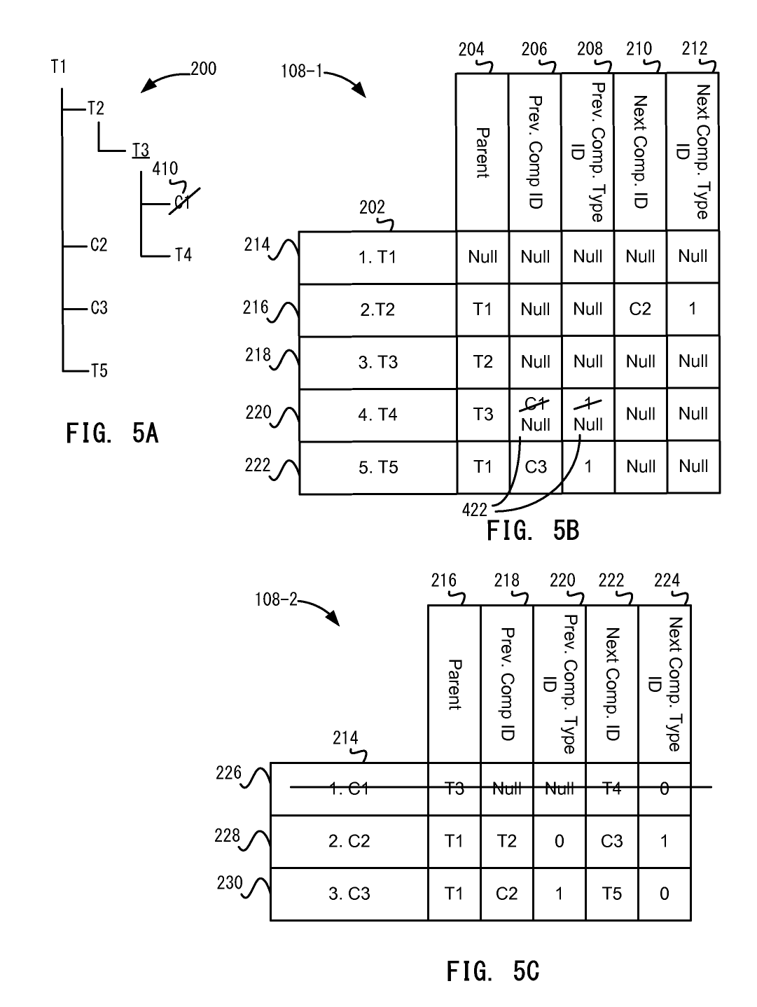

In addition to adding a component, a user may delete a component from the structure. FIG. 5A shows an example of deleting a component according to one embodiment. In this example, column C1 may be deleted from the data at 410. FIG. 5B shows the changes to metadata table 108-1 and FIG. 5C shows the changes to metadata table 108-2 according to one embodiment. In FIG. 5B, the deletion of column C1 affects the previous component for table T4. In this case, at 412, ETL tool 110 changes the value of column C1 to null and the value of 1 is changed to null. This indicates that table T4 does not have a previous component anymore.

In FIG. 5C, ETL tool 110 deletes the information for column C1 from column 108-2. No other information is affected in metadata table 108-2. However, if additional information to the previous or next components was needed due to the deletion, ETL tool 110 would modify the information in metadata table 108-2.

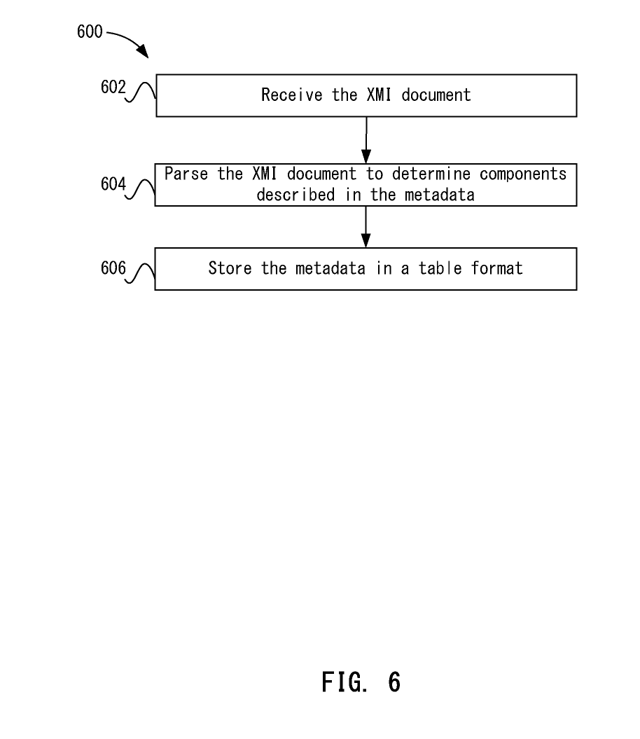

FIG. 6 depicts a simplified flowchart 600 of a method for storing metadata in metadata tables 108-1 and 108-2 according to one embodiment. At 602, ETL tool 110 receives the XMI document, or another document in a serial or non-database table format. At 604, ETL tool 110 parses the XMI document to determine components described in the metadata. The structure of the components includes a nested structure of the components and also an ordering of the components in the data.

At 606, ETL tool 110 stores the metadata in a table format. For example, the columns of metadata tables 108-1 and 108-2 are used to define the nested structure of the components and the order of the components in the metadata.

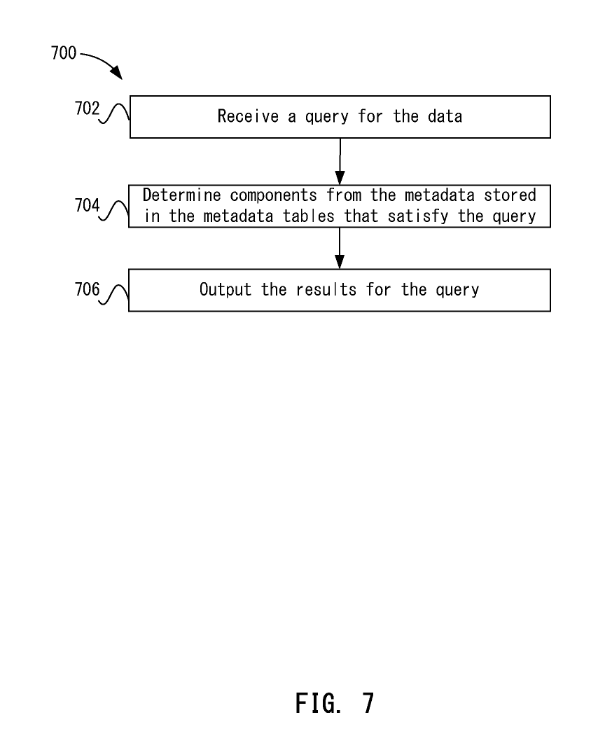

Once ETL tool 110 stores the metadata in the columns of metadata tables 108-1 and 108-2, ETL tool 110 can respond to queries. FIG. 7 depicts a simplified flowchart 700 of a method for responding to queries from user interface 114 according to one embodiment. At 702, ETL tool 110 receives a query for the data. For example, user interface 114 may want to display the structure of certain components in the data.

At 704, ETL tool 110 determines components from the metadata stored in metadata tables 108-1 and 108-2 that satisfy the query. For example, the components determined are in the nested structure and the order defined in the metadata. Also, ETL tool 110 may only retrieve a certain number of layers of the structure.

At 706, ETL tool 110 outputs the results for the query. The result includes the determined components in the nested structure and also the order retrieved from metadata tables 108-1 and 108-2.

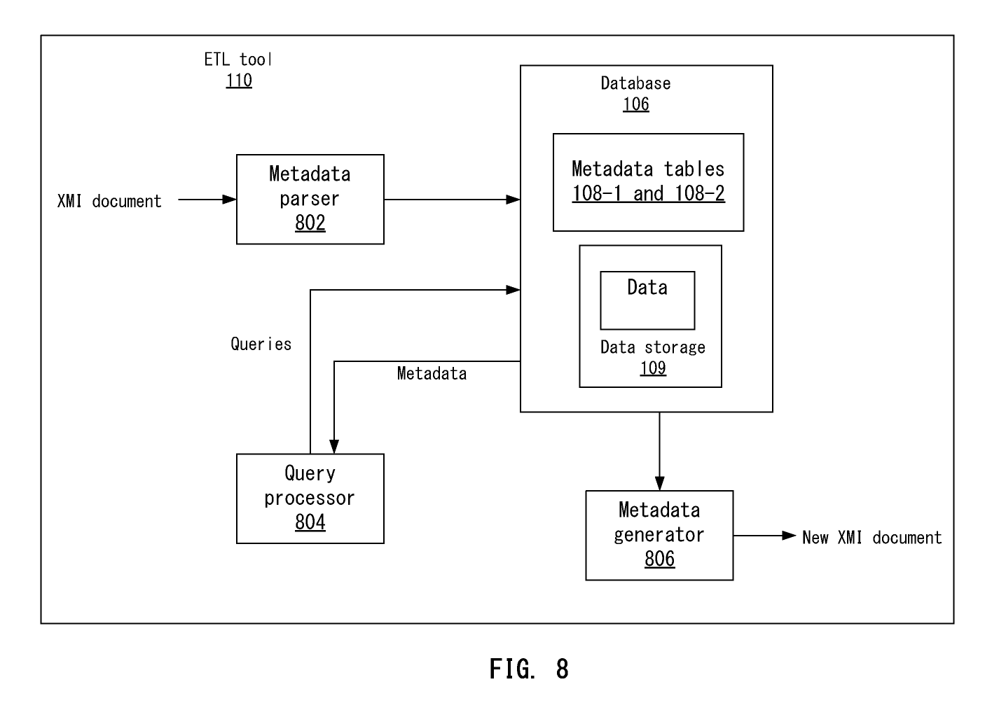

FIG. 8 depicts a more detailed example of ETL tool 110 according to one embodiment. A metadata parser 802 receives the XMI document. Metadata parser 802 may then parse the metadata in the XMI document and generate metadata tables 108-1 and 108-2.

Once metadata tables 108-1 and 108-2 are generated, a query processor 804 may process queries from user interface 114. For example, query processor 804 may retrieve information from metadata tables 108-1 and 108-2. Then, query processor 804 responds to the query by providing information on the structure of components in the metadata. Also, query processor 804 may add components and delete components from metadata tables 108-1 and 108-2. This modifies the information for the ordering of the components or the nested structure of the components in metadata tables 108-1 and 108-2.

The changes to the structure may not be reflected in a current XMI document. That is, changes to metadata tables 108-1 and 108-2 do not cause the regeneration of the XMI document after each change. However, a metadata generator 806 may retrieve the information in metadata tables 108-1 and 108-2 and generate an XMI document when needed. The XMI document includes the metadata in the serial format as reflected by the information in metadata tables 108-1 and 108-2.

Accordingly, storing metadata in the table-based format is straightforward and can be queried in a quicker way by ETL tool 110. Previously, ETL tool 110 had to parse the whole XMI document for each query. However, in particular embodiments, metadata can be read layer by layer. In this case, the layers of the structure may only be loaded and rendered if needed by user interface 114. This saves time and workload.

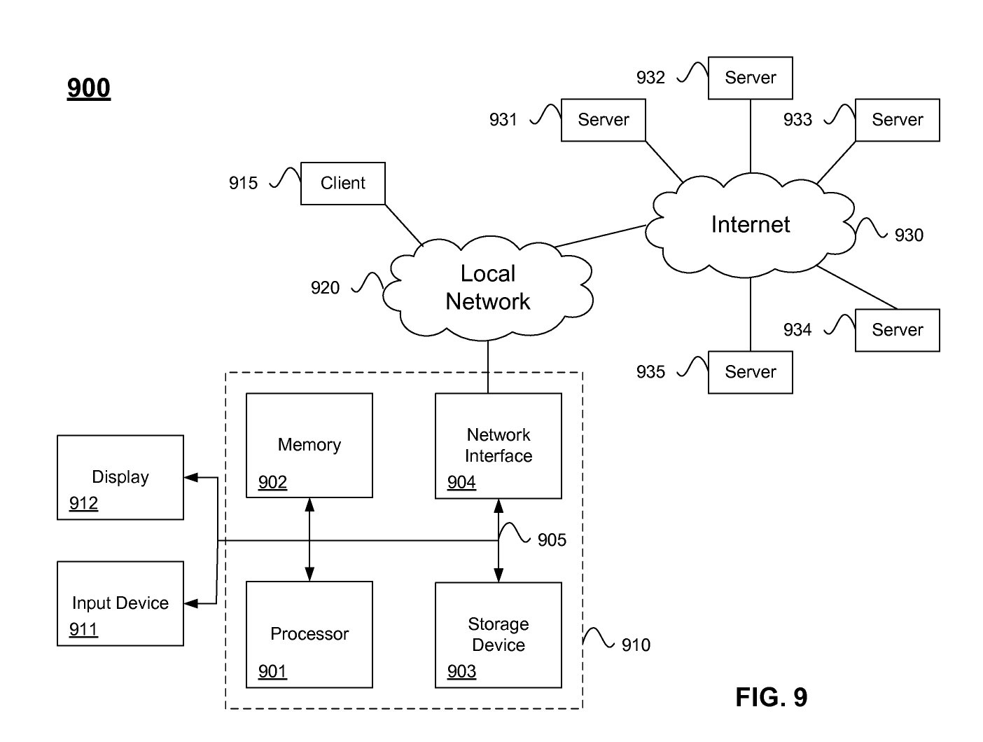

FIG. 9 illustrates hardware of a special purpose computing machine configured with ETL tool 110 according to one embodiment. An example computer system 910 is illustrated in FIG. 9. Computer system 910 includes a bus 905 or other communication mechanism for communicating information, and a processor 901 coupled with bus 905 for processing information. Computer system 910 also includes a memory 902 coupled to bus 905 for storing information and instructions to be executed by processor 901, including information and instructions for performing the techniques described above, for example. This memory may also be used for storing variables or other intermediate information during execution of instructions to be executed by processor 901. Possible implementations of this memory may be, but are not limited to, random access memory (RAM), read only memory (ROM), or both. A storage device 903 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 903 may include source code, binary code, or software files for performing the techniques above, for example. Storage device and memory are both examples of computer readable storage mediums.

Computer system 910 may be coupled via bus 905 to a display 912, such as a cathode ray tube (CRT) or liquid crystal display (LCD), for displaying information to a computer user. An input device 911 such as a keyboard and/or mouse is coupled to bus 905 for communicating information and command selections from the user to processor 901. The combination of these components allows the user to communicate with the system. In some systems, bus 905 may be divided into multiple specialized buses.

Computer system 910 also includes a network interface 904 coupled with bus 905. Network interface 904 may provide two-way data communication between computer system 910 and the local network 920. The network interface 904 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 904 sends and receives electrical, electromagnetic, or optical signals that carry digital data streams representing various types of information.

Computer system 910 can send and receive information through the network interface 904 across a local network 920, an Intranet, or the Internet 930. In the Internet example, software components or services may reside on multiple different computer systems 910 or servers 931-935 across the network. The processes described above may be implemented on one or more servers, for example. A server 931 may transmit actions or messages from one component, through Internet 930, local network 920, and network interface 904 to a component on computer system 910. The software components and processes described above may be implemented on any computer system and send and/or receive information across a network, for example.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
receiving, by a computing device, a document including metadata in a serial format;
parsing, by the computing device, the document to determine components in the metadata, a nested structure of the components, and an order of the components in the data;
storing, by the computing device, the metadata in a table format, wherein columns of the table define the nested structure of the components and the order of the components in the data;
receiving, by the computing device, a query for the data;
determining, by the computing device, components from the metadata stored in the table format from the columns of the table that satisfy the query, wherein the components are determined based on the nested structure of the determined components and the order of the determined components from information in the columns of the table; and
outputting, by the computing device, a result for the query, the result including the determined components based on the nested structure of the determined components and the order of the determined components.

2. The method of claim 1, wherein determining the components comprises executing a procedure to determine tables in the data, wherein the tables are in a nested structure.

3. The method of claim 2, wherein a layer depth of tables that are determined are based on a layer restriction on a number of nested layers to determine.

4. The method of claim 1, wherein determining the components comprises executing a procedure to determine components for a table in an order.

5. The method of claim 4, wherein the components comprise tables and columns in the order.

6. The method of claim 1, further comprising:
adding a component to the data, wherein the added component changes at least one of the nested structure of the components and the order of the components in the data; and
adjusting the metadata in the table format such that the columns of the table represent the changes to the at least one of the nested structure of the components and the order of the components in the data.

7. The method of claim 1, further comprising:
deleting a component to the data, wherein the deleted component changes at least one of the nested structure of the components and the order of the components in the data; and
adjusting the metadata in the table format such that the columns of the table represent the changes to the at least one of the nested structure of the components and the order of the components in the data.

8. The method of claim 1, wherein the columns comprises a parent table identifier column that identifies a parent of a component, a previous component identifier column that identifies a previous component in the order for the component, a previous component type that identifies a type of the previous component, a next component identifier column that identifies a next component in the order for the component, a next component type that identifies a type of the next component.

9. The method of claim 1, wherein the nested structure includes a table that includes sub-tables and columns.

10. A non-transitory computer-readable storage medium containing instructions, that when executed, control a computer system to be configured for:
receiving a document including metadata in a serial format;
parsing the document to determine components in the metadata, a nested structure of the components, and an order of the components in the data;
storing the metadata in a table format, wherein columns of the table define the nested structure of the components and the order of the components in the data;
receiving a query for the data;
determining components from the metadata stored in the table format from the columns of the table that satisfy the query, wherein the components are determined based on the nested structure of the determined components and the order of the determined components from information in the columns of the table; and
outputting a result for the query, the result including the determined components based on the nested structure of the determined components and the order of the determined components.

11. The non-transitory computer-readable storage medium of claim 10, wherein determining the components comprises executing a procedure to determine tables in the data, wherein the tables are in a nested structure.

12. The non-transitory computer-readable storage medium of claim 11, wherein a layer depth of tables that are determined are based on a layer restriction on a number of nested layers to determine.

13. The non-transitory computer-readable storage medium of claim 10, wherein determining the components comprises executing a procedure to determine components for a table in an order.

14. The non-transitory computer-readable storage medium of claim 13, wherein the components comprise tables and columns in the order.

15. The non-transitory computer-readable storage medium of claim 10, further configured for:
adding a component to the data, wherein the added component changes at least one of the nested structure of the components and the order of the components in the data; and
adjusting the metadata in the table format such that the columns of the table represent the changes to the at least one of the nested structure of the components and the order of the components in the data.

16. The non-transitory computer-readable storage medium of claim 10, further configured for:
deleting a component to the data, wherein the deleted component changes at least one of the nested structure of the components and the order of the components in the data; and
adjusting the metadata in the table format such that the columns of the table represent the changes to the at least one of the nested structure of the components and the order of the components in the data.

17. The non-transitory computer-readable storage medium of claim 10, wherein the columns comprises a parent table identifier column that identifies a parent of a component, a previous component identifier column that identifies a previous component in the order for the component, a previous component type that identifies a type of the previous component, a next component identifier column that identifies a next component in the order for the component, a next component type that identifies a type of the next component.

18. The non-transitory computer-readable storage medium of claim 10, wherein the nested structure includes a table that includes sub-tables and columns.

19. An apparatus comprising:
one or more computer processors; and
a non-transitory computer-readable storage medium comprising instructions, that when executed, control the one or more computer processors to be configured for:
receiving a document including metadata in a serial format;
parsing the document to determine components in the metadata, a nested structure of the components, and an order of the components in the data;
storing the metadata in a table format, wherein columns of the table define the nested structure of the components and the order of the components in the data;
receiving a query for the data;
determining components from the metadata stored in the table format from the columns of the table that satisfy the query, wherein the components are determined based on the nested structure of the determined components and the order of the determined components from information in the columns of the table; and
outputting a result for the query, the result including the determined components based on the nested structure of the determined components and the order of the determined components.

20. The apparatus of claim 19, wherein the columns comprises a parent table identifier column that identifies a parent of a component, a previous component identifier column that identifies a previous component in the order for the component, a previous component type that identifies a type of the previous component, a next component identifier column that identifies a next component in the order for the component, a next component type that identifies a type of the next component.
